(19) United States
(12) Patent Application Publication
(10) Pub. No.: US 2002/0089646 A1
(43) Pub. Date: Jul. 11, 2002

(54) Web movie system

(75) Inventor: Jung-Kuei Chang, Taipei (TW)

Correspondence Address: David e. Dougherty, Dennison, Schultz & Dougherty, 612 Crystal Square 4, 1745 Jefferson Davis Highway, Arlington, VA, 22202, US

(73) Assignee: Spring House Entertainment Inc.

(21) Appl. No.: 09/756,710

(22) Filed: Jan. 10, 2001

(51) Int. Cl. G03B 29/00

(52) U.S. Cl. 352/131

(57) ABSTRACT

A web movie system is formed through a web site, and is designed according to the characteristics of Internet. Thereby, the multimedia interaction, the user can understand all information of a movie and select the movie clips according to the time of the user connected to the network. A layer and non-linear video editing concepts are used in the web movie system, so that the movie frame is edited into a plurality of scene layers (such as a front scenery, a middle scenery, and a background) according to the captured depths of the scenery so that the editing time is reduced greatly.

### FIELD OF THE INVENTION

The present invention relates to a web movie system, wherein the amount of data file can be greatly reduced and the quality of the frame is increased and the speed of the network is increased. The roles in the movie and the contents are replaceable so that the content of the movie becomes more vivid.

### BACKGROUND OF THE INVENTION

Due to the progress of technology, people may see movies at home through a network. However, in the prior art movie, the video and audio contents are fixed, i.e. unchanged. Since the amount of data of a movie is very large, the executing speed and resolution are low. The resolution is only 320×480 or 240×160 pixel. The playing is conventional. The property of network platform can not be used. The audience only sees a continuous story. The age, roles, scenery, objects in the story are fixed and the audience accepts all these information. However, the original contents can not be changed and thus has a low utility. For example, an advertise content is fixed, however, if some clips therein can be changed, then the original content can be reused only by replacing some clips therein. For example, a role in an advertisement can be replaced, and then, the user may download the data according to a counter, a record board and desktop.

### SUMMARY OF THE INVENTION

Accordingly, the primary object of the present invention is to provide a web movie system, through Internet, the user may view a movie and interacts with the network. The web movie system is as a web site of Internet, all the information of a movie is presented by a multimedia interaction. The clip of a movie is selectable according to the network-connecting time.

Another object of the present invention is to provide a web movie system, thereby, the time and cost for production a movie can be greatly reduced. The worth of the system is increased.

A further object of the present invention is to provide a web movie system, the amount of data file can be greatly reduced and the quality of the frame is increased and the speed of the network is increased.

To achieve above objects, the present invention provides a web movie system mainly including a network playing platform, a plurality of keys for selecting, switching and downloading, a plurality of movie clips which are video edited nonlinearly, and electronic document for introducing the related contents of movies. In that, each clip is divided into different scene layers. Each scenery is installed by a plurality of scene layers. Namely, the frames of a movie are edited longitudinally into different scene layers (for example, a front scenery, a middle scenery, a rear scenery). Each scene layer is formed by a plurality of components. The elements include static scene, dynamic images, animations, voices and texts. Each scene layer can be interpreted independent. Each element can be updated as desired. Thereby, the time and cost for production a movie can be reduced so that the interpret work is flexible. Furthermore, the appended worth for the commodity advertisement can be increased (for example, the handset for the leading role is A type, while a B type handset will be commercially sold, then the scenery of handset can be updated by B type). By the interaction of network playing platform, the presenting movie is vivid (for example, according to the network, the actors are substituted). The electronic elements are constructed by interacted multimedia. The introduction of the multimedia may be selected through the key or from the element on the movie frame so that the content includes introduction of movies, introduction of roles, introduction of scenery and prompt of clue, etc. The whole web site is like a complete article. The web movie system according to the present invention can be added with a general network so that the electronic congratulating cards, recording board, downloading of screen protection program, and downloading of desktop are added in the network so as the audiences may interact with each other. The resolution in the frame can be increased to 720×486 pixels. Different qualities of frame and sound (compression ratio of video and audio can be adjusted according to bandwidth). A real dynamic image can be presented by image processing effect and 2D computer animation. The moving effect can be achieved by 2D vector animation. Therefore, the amount of data can be reduced greatly and the speed of network transmission can be speeded.

The various objects and advantages of the present invention will be more readily understood from the following detailed description when read in conjunction with the appended sence.

### BRIEF DESCRIPTION OF THE DRAWINGS

FIG. 1 is a plane view of a prior art web movie.

FIG. 2 is a plane view of the web movie system of the present invention.

FIG. 3 shows a structure of the web movie system in the present invention.

FIG. 4 shows the production flow of the web movie of the present invention.

FIG. 5-1 to 5-6 show an embodiment that in the present invention, images are matched to the animation production through different layer.

FIG. 6 shows the structure of the web movie system in the present invention.

### DETAILED DESCRIPTION OF THE PREFERRED EMBODIMENTS

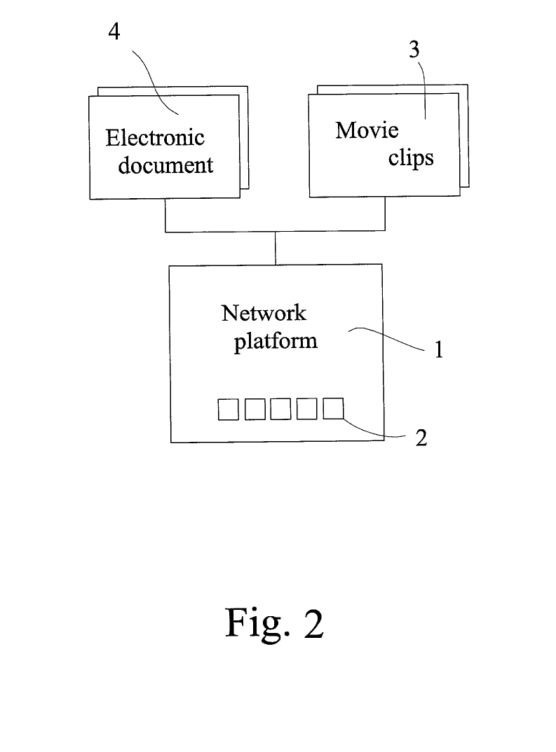

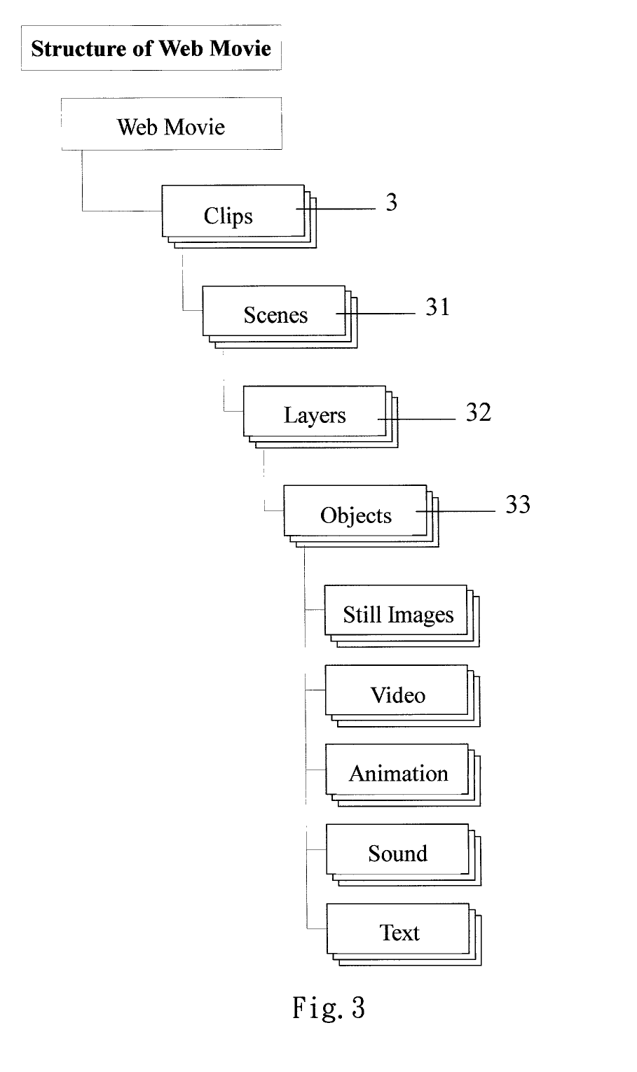

The web movie system of the present invention is illustrated in FIGS. 2, and 3. The web movie system mainly includes a network playing platform 1, a plurality of keys 2 for selecting, switching and downloading, a plurality of movie clips 3 which are video edited nonlinearly, and electronic document 4 for introducing the related contents of movies. In that, each clip 3 is divided into different sceneries 31. Each scenery 31 is installed by a plurality of scene layers 32. Namely, the frames of a movie are edited longitudinally into different scene layers (for example, a front scenery, a middle scenery, a rear scenery). Each scene layer 32 is formed by a plurality of components. The elements 33 include static scene, dynamic images, animations, voices and texts. Each scene layer 32 can be interpreted independent. Each element 33 can be updated as desired.

Thereby, the time and cost for production a movie can be reduced so that the interpret work is flexible. Furthermore, the appended worth for the commodity advertisement can be increased (for example, the handset for the leading role is A type, while a B type handset will be commercially sold, then the scenery of handset can be updated by B type). By the interaction of network playing platform, the presenting movie is vivid (for example, in the network, the actors are substituted).

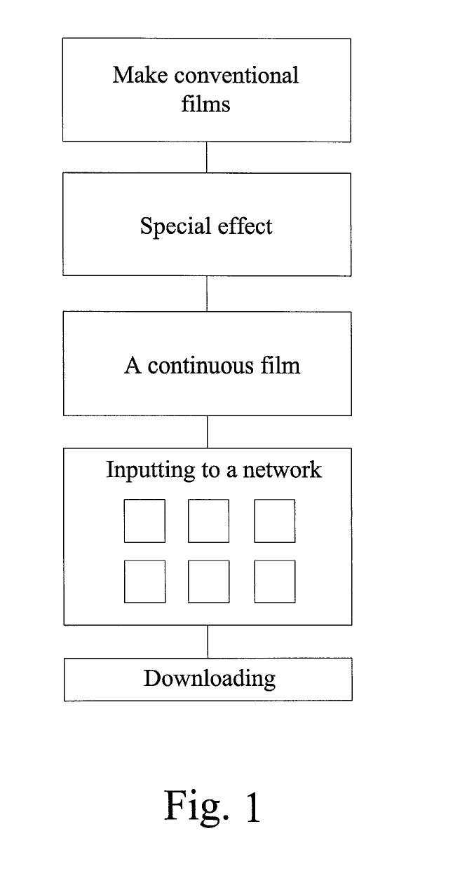

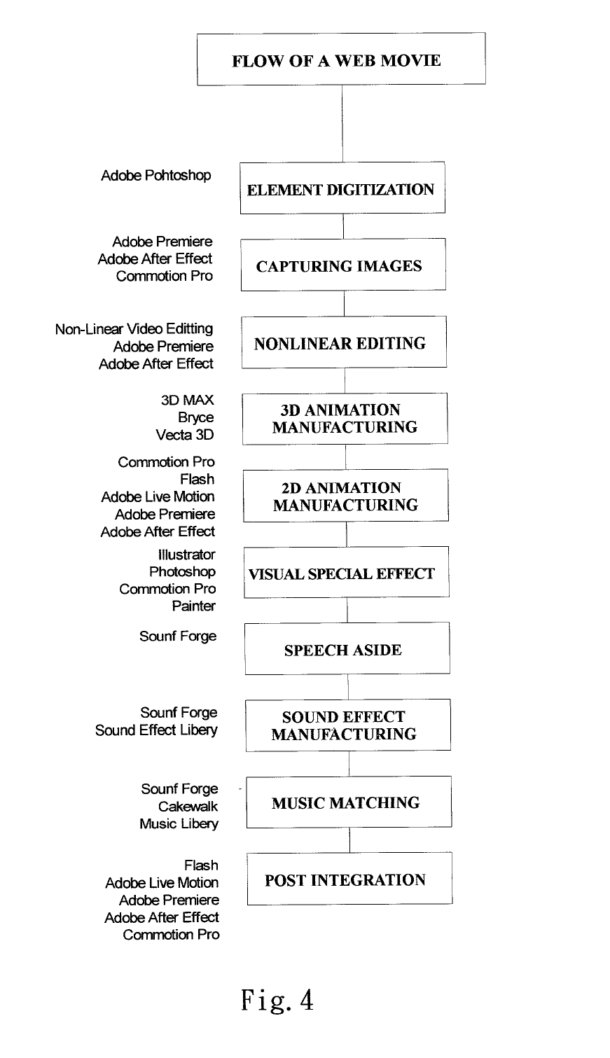

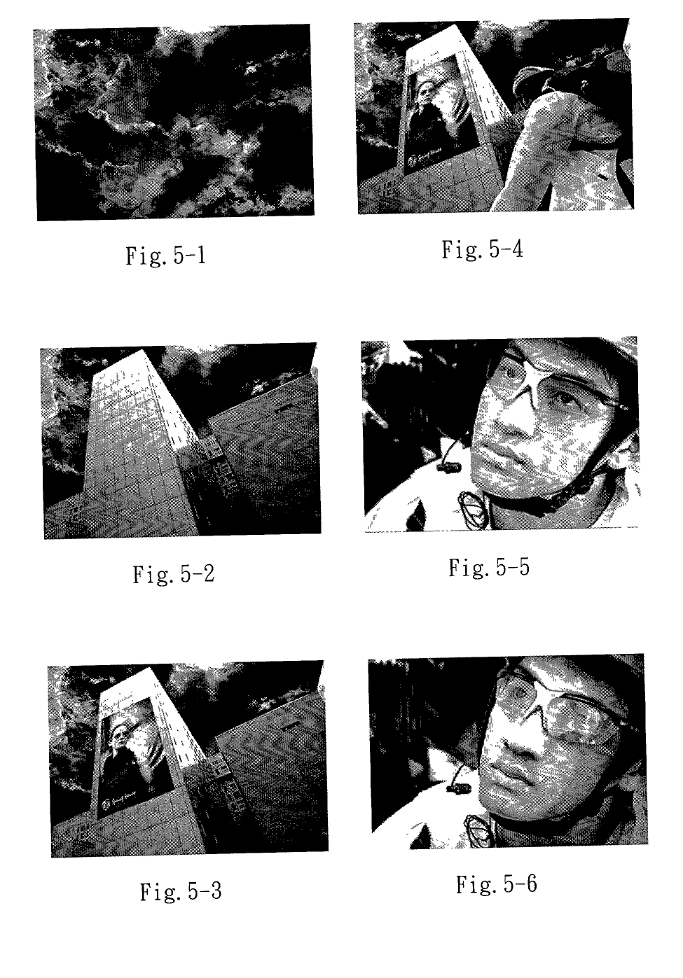

With reference to FIGS. 4 and 5, the flow diagram for production the web movie of the present invention and the embodiment of clips are illustrated. If the audiences hope that in that movie, as the leading role passes through a building by riding a motorcycle, the head of the leading role looks upwards so as to see a beautiful girl on an advertisement board). Other than the business of a movie and getting pictures in advance, the movie is necessary to perform the later operation of digitalization, image capturing, editing and combination of various clips, matching to a 3D and 2D animation, special visual feeling, speech aside, audio effect, music integration. The characteristics of the present invention is illustrated in FIGS. 5-1 and 5-6, the following description is along an order of from the upper side to the lower side and from the left side to the right side: the element in this scenery is taken out independently, such as a background of sky, buildings, a big playbill on the building, a scene layer showing the male lead riding on bicycles. Each accomplished element is placed into different scene layers. Then the dynamic action and visual effect of each element is designed to each scene layer. After the production of each scenery is complete, a complete web movie clip is assembled so as to be formed with a complete movie clip. Then the scripts of the movie clips are stored. Then, according to different network environments, the web movie products with various compression ratios can be outputted.

If the aforesaid sence in a movie is captured and editing in the conventional way, it will occupy a plurality of continuous image files. Furthermore, the roles or elements can not be updated after capturing. While, in the present invention, the elements are outputted by integration, from the leading role presenting to the role seeing the board, only several k bytes are necessary so that amount of the image file is greatly reduced. Moreover, the downloading time on a network is reduced effectively and the movie can be played smoothly. The resolution in the frame can be increased to 720×486 pixels. More importantly, the components 33 can be updated easily for prolonging the lifetime of the movie. The audience may see the movie with a new role therein and the cloth and other decorations can be updated as desired.

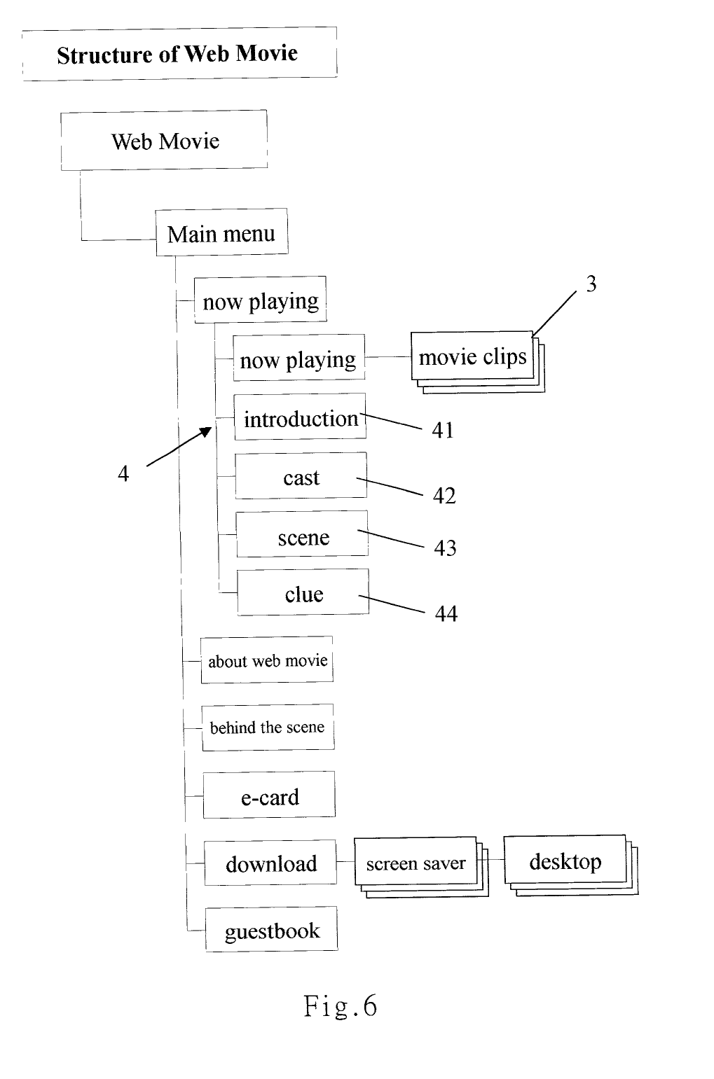

Referring to FIGS. 4, and 6, the movie of the present invention and the network are combined preferably. The electronic elements are constructed by interacted multimedia. The introduction of the multimedia may be selected through the key 2 or from the element 33 on the movie frame so that the content includes introduction of movies 41, introduction of roles 42, introduction of scenery 43 and prompt of clue 44, etc. The whole web site is like a complete article. Not only having the function of a movie, but also it is like a fiction so that the introduction of story of a play is enhanced and clue helpful to the movie is provided to the audience.

Of course, the web movie system according to the present invention can be added with a general network so that the functions of electronic congratulating cards, recording board, downloading of screen protection program, and downloading of desktop are added in the network so as the audiences may interact with each other.

Besides, in order to match the life timing of the audiences, the web movie is divided into a plurality of clips 3 so that they may be played at different timing or for some specific commercial requirement. In this web movie system, the playing of movie clip 3 may be confined, for example, through input an encryption code or other requirement condition, if cooperating with as the traditional movie theater, the dialogue or clue of the web movie maybe arranged to function as a preview, or correspondence to it so as to reach a high-light effect.

In order to produce related works of the movie, a preset output format is manufactured in the web movie so that the plurality of movie clips 3 are used with electronic documents 4 so as to be formed as an output files of VCD, DVD, etc so that the plurality of movie clips 3 are used to the multimedia electronic document 4 to become a work of documentary publication.

Therefore, from above description, it is appreciated that by the present invention, the playing and production of movies enters into a new age. Other than the file is compressed and transferring speed is increased, the frame quality and resolution are increased. Moreover, the related element and roles can be updated rapidly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A web movie system playing a movie through Internet, for audiences to view the movie through a browser and to be able to interact with the web movie system; the web movie system including a network playing platform, a plurality of keys for selecting, switching and downloading, a plurality of movie clips connected nonlinearly, and electronic documents for introducing the related contents of movies wherein each clip is divided into different scenes; each scenery is installed by a plurality of scene layers, namely, the image frames of a plurality of movie clips are editing longitudinally into different scene layers; each scene layer is formed by a plurality of components; each scene layer being interpreted independently; each element being updated as desired; thereby, the amount of data in the movie being reduced, the quality of frame being increased and the transferring speed in the network being increased.

2. The web movie system as claimed in claim 1, wherein the elements includes static scene, dynamic images, animations, voices and texts, and the electronic document is formed by interactive multimedia.

3. The web movie system as claimed in claim 3, wherein content includes an introduction of movies, an introduction of roles, an introduction of scenery and prompts of clues.

4. The web movie system as claimed in claim 1, wherein electronic congratulating cards, recording boards, downloading of screen protection programs, and downloading of desktops are added in the network.

5. The web movie system as claimed in claim 1, wherein the movie is necessary to perform a series of succeeding operations of digitalization, image capturing, cutting and combination of various clips, matching to a 3D and 2D animation, special visual feeling, speech aside, audio effect, music integration

6. The web movie system as claimed in claim 1, wherein the resolution is 720×486 pixels.

7. The web movie system as claimed in claim 1, wherein the playing of a movie clip is confined by checking an encryption code or other requirement condition.

8. The web movie system as claimed in claim 1, wherein introduction of the multimedia may be selected an element on the movie frame directly.

9. The web movie system as claimed in claim 1, wherein a output format is manufactured in the web movie so that the plurality of movie clips are used with electronic documents so as to be formed as an output files of VCD, and DVD.

10. The web movie system as claimed in claim 1, wherein an output format is manufactured in the web movie so that the plurality of movie clips are used with electronic documents so as to be formed as an output files of a published article.
